(19) United States
(12) Patent Application Publication
(10) Pub. No.: US 2025/0229607 A1
(43) Pub. Date: Jul. 17, 2025

(54) DEHUMIDIFICATION DEVICE, HEATER ELEMENT FOR DEHUMIDIFICATION DEVICES, AND VEHICLE INTERIOR DEHUMIDIFICATION SYSTEM

(71) Applicant: NGK INSULATORS, LTD., Nagoya-City (JP)

(72) Inventors: Toshiki IWATSUKI, Chita-Shi (JP); Yukio MIYAIRI, Nagoya-Shi (JP); Masaaki MASUDA, Nagoya-Shi (JP); Takuya NAKASHIMA, Nagoya-Shi (JP); Toru HAYASE, Nagoya-Shi (JP); Hirofumi YAMAGUCHI, Komaki-Shi (JP)

(73) Assignee: NGK INSULATORS, LTD., Nagoya-City (JP)

(21) Appl. No.: 19/171,432

(22) Filed: Apr. 7, 2025

Related U.S. Application Data
(63) Continuation of application No. PCT/JP2023/035483, filed on Sep. 28, 2023.

(30) Foreign Application Priority Data
Oct. 28, 2022 (JP) 2022-173641

(51) Int. Cl. B60H 3/02; H05B 3/12

(52) U.S. Cl. CPC B60H 3/024; H05B 3/12

(57) ABSTRACT

A dehumidification device according to an embodiment may include: a heater element including a honeycomb structure having an outer peripheral wall and partition walls provided on an inner side of the outer peripheral wall, the partition walls defining a plurality of cells, each of the cells extending from a first end face to a second end face of the honeycomb structure to form a flow path, at least the partition walls being made of a material having a PTC property, and a pair of electrodes provided on the honeycomb structure; and a dehumidifying material-containing layer provided on surfaces of the partition walls, the dehumidifying material-containing layer containing a dehumidifying material having a water release temperature of 30 to 70° C.

### CROSS REFERENCE TO RELATED APPLICATIONS

This application claims the benefit of priorities to Japanese Patent Application No 2022-173641 filed on Oct. 28, 2022 and PCT Patent Application No. PCT/JP2023/035483 filed on Sep. 28, 2023, the entire contents of which are incorporated herein by reference in its entirety.

### BACKGROUND

The disclosure may relate to a dehumidification device, a heater element for dehumidification devices, and a vehicle interior dehumidification system.

There is a growing demand to reduce CO₂ emissions from automobiles as a measure against global warming. There is also a growing demand to reduce emissions of nitrogen oxides and the like from automobiles as a measure against air pollution. Electric vehicles are attracting attention as effective solutions to these problems.

However, electric vehicles do not have an internal combustion engine, which is used as a heat source for heating of conventional vehicles, and thus, they have a problem of lacking a heat source for heating. Since most of the heating energy is lost through ventilation, less ventilation may be considered. However, without ventilation, driving safety is compromised because moisture from human exhalation (water vapor) increases the humidity in the vehicle interior, and is in contact with cold window glass to generate fogging thereon.

Therefore, a dehumidification device has been proposed that reduces the humidity in a vehicle interior by causing moisture in the vehicle interior to be adsorbed by a dehumidifying material in a dehumidifier, and regenerates the dehumidifying material in the dehumidifier by bringing the air to a high temperature with a heating device placed upstream of the dehumidifier and allowing that air to flow through the dehumidifier to release the moisture to the vehicle exterior (e.g., Patent Literature 1). The heating device used in the dehumidification device employs a heater element that utilizes Joule heat, and the like.

However, the heater element that utilized Joule heat has a problem that it tends to increase the size and reduces the space inside the vehicle. Therefore, it may be preferable that more compact heater elements are used. In this regard, it is known that a heater element provided with a honeycomb structure having a PTC property is advantageous because it can increase a heat transfer area per unit volume and prevent excessive heat generation (e.g., Patent Literature 2).

### PATENT LITERATURES

[Patent Literature 1] Japanese Patent No. 6513170 B
[Patent Literature 2] WO 2020/036067 A1

### SUMMARY

The dehumidification device described above is provided with the heating device (heater element) upstream of the dehumidifying material, which requires a space for placing both the dehumidifying material and the heating device and tends to increase the size. The dehumidification device also indirectly heat the dehumidifying material that has absorbed the moisture by the air heated by the heating device, so that the regeneration efficiency of the dehumidifying material may not be sufficient. Additionally, some types of dehumidifying materials used in the dehumidification device may have higher temperatures at which the adsorbed moisture can be released, so that the electrical energy required for increasing the heating temperature may be higher.

An object of one or more embodiments of the disclosure may be is to provide: a dehumidification device which has a higher efficiency for regenerating the dehumidifying material, and which can decrease the size and reduce power consumption; a heater element for dehumidification devices, which is useful for producing the dehumidification device; and a vehicle interior dehumidification system including the dehumidification device.

As a result of extensive studies on the structures of dehumidification devices, the inventors have found that the above problems may be solved by providing a dehumidifying material-containing layer containing a dehumidifying material having a water release temperature of 30 to 70° C. on surfaces of partition walls of a honeycomb structure making up a heater element.

An aspect of one or more embodiments may be a dehumidification device that may include:
a heater element comprising: a honeycomb structure having an outer peripheral wall and partition walls disposed on an inner side of the outer peripheral wall, the partition walls defining a plurality of cells, each of the cells extending from a first end face to a second end face of the honeycomb structure to form a flow path, at least the partition walls being made of a material having a PTC property; and a pair of electrodes provided on the honeycomb structure; and
a dehumidifying material-containing layer provided on surfaces of the partition walls, the dehumidifying material-containing layer comprising a dehumidifying material having a water release temperature of 30 to 70° C.

An aspect of one or more embodiments may be a heater element for dehumidification devices. The heater element may include:
a honeycomb structure having an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; and a pair of electrodes provided on the honeycomb structure,
wherein the material having the PTC property has a Curie point of 30 to 70° C.

An aspect of one or more embodiments may be a vehicle interior dehumidification system that may include:
the dehumidification device;
a battery configured to apply voltage to the dehumidification device;
an inflow pipe communicating a vehicle interior with an inflow port of the dehumidification device;
an outflow pipe communicating an outflow port of the dehumidification device with the vehicle interior and a vehicle exterior;
a switching valve provided in the outflow pipe, the switching valve being configured to switch the flow of air flowing through the outflow pipe to the vehicle interior or the vehicle exterior.

According to at least one of the aspects described above, it may be possible to provide a dehumidification device which has a higher efficiency for regenerating dehumidifying material, and which can decrease the size and reduce power consume; a heater element for dehumidification devices, which is useful for producing the dehumidification device; or a vehicle interior dehumidification system including the dehumidification device.

### BRIEF DESCRIPTION OF THE DRAWINGS

FIG. 1 is a schematic view of a dehumidification device according to an embodiment;

FIG. 2 is a schematic cross-sectional view taken along the line a-a′ in FIG. 1;

FIG. 3 is a schematic view on a first end face side of a dehumidification device according to an embodiment;

FIG. 4 is a schematic cross-sectional view taken along the line a-a′ in FIG. 3;

FIG. 5 is a schematic view illustrating a configuration of a vehicle interior dehumidification system according to an embodiment; and

FIG. 6 is a schematic view illustrating a configuration of a vehicle interior dehumidification system according to another embodiment.

### DETAILED DESCRIPTION

A dehumidification device according to an embodiment includes: a heater element; and a dehumidifying material-containing layer. The heater element includes a honeycomb structure and a pair of electrodes provided on the honeycomb structure. The honeycomb structure includes an outer peripheral wall and partition walls disposed on an inner side of the outer peripheral wall, the partition walls defining a plurality of cells, each of the cells extending from a first end face to a second end face of the honeycomb structure to form a flow path, at least the partition walls being made of a material having a PTC (Positive Temperature Coefficient) property. The dehumidifying material-containing layer is provided on surfaces of the partition walls, and the dehumidifying material-containing layer contains a dehumidifying material having a water release temperature of 30 to 70° C.

The “water release temperature” of the dehumidifying material as used herein refers to a temperature at which the moisture adsorbed on the dehumidifying material can be released.

With the above configuration, it is possible to eliminate the space required for placing the dehumidification material separately from the heater element, thereby downsizing the dehumidification device. Further, the heater element can directly heat the dehumidifying material-containing layer, thereby improving the regeneration efficiency of the dehumidifying material. Furthermore, since the water release temperature of the dehumidifying material contained in the dehumidifying material-containing layer is controlled, the electric energy required for increasing the heating temperature can also be reduced.

A heater element for dehumidification devices according to an embodiment includes: a honeycomb structure having an outer peripheral wall and partition walls disposed on an inner side of the outer peripheral wall, the partition walls defining a plurality of cells, each of the cells extending from a first end face to a second end face of the honeycomb structure to form a flow path, at least the partition walls being made of a material having a PTC property; and a pair of electrodes provided on the honeycomb structure, wherein the material having the PTC property has a Curie point of 30 to 70° C.

With the above configuration, the heater element for dehumidification devices according to an embodiment can be provided with a dehumidifying material-containing layer having a water release temperature of 30 to 70° C.

A vehicle interior dehumidification system according to an embodiment includes: the dehumidification device; a battery configured to apply voltage to the dehumidification device; an inflow pipe communicating a vehicle interior with an inflow port of the dehumidification device; an outflow pipe communicating an outflow port of the dehumidification device with the vehicle interior and a vehicle exterior; and a switching valve provided in the outflow pipe, the switching valve configured to switch the flow of air flowing through the outflow pipe to the vehicle interior or the vehicle exterior.

The above configuration of the vehicle interior dehumidification system according to an embodiment enables downsizing and reduction of power consumption.

Hereinafter, embodiments of the disclosure will be specifically described with reference to the drawings. It should be understood that the invention is not limited to the following embodiments, and those which have appropriately added changes, improvements and the like to the following embodiments based on knowledge of a person skilled in the art without departing from the spirit of the invention fall within the scope of the invention.

### (1. Dehumidification Device)

The dehumidification device according to an embodiment can be suitably used to control the interior humidity in various vehicles, such as automobiles. The vehicle includes, but not limited to, automobiles and rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the dehumidification device according to an embodiment can be suitably used for a vehicle that has no internal combustion engine such as electric vehicles and electric rail cars.

In addition to vehicles, the dehumidification devices according to an embodiment can also be used to control indoor humidity in buildings such as houses, offices, factories, stores, and warehouses, and in vehicles such as ships and airplanes.

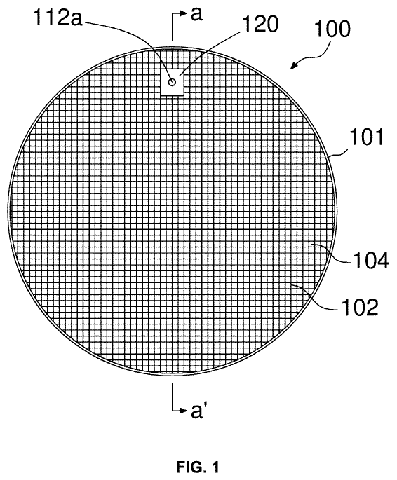

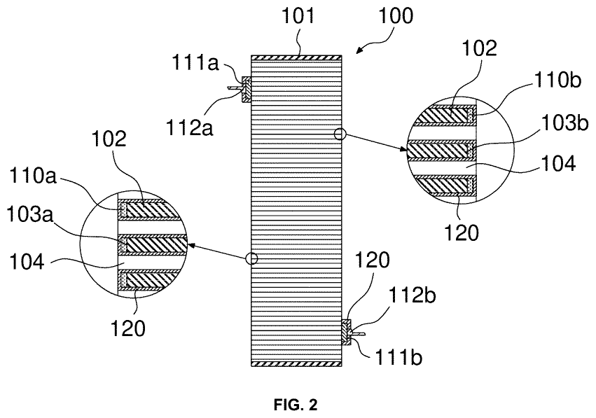

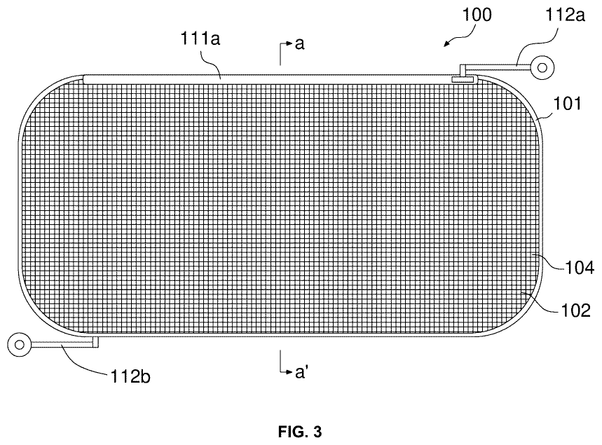

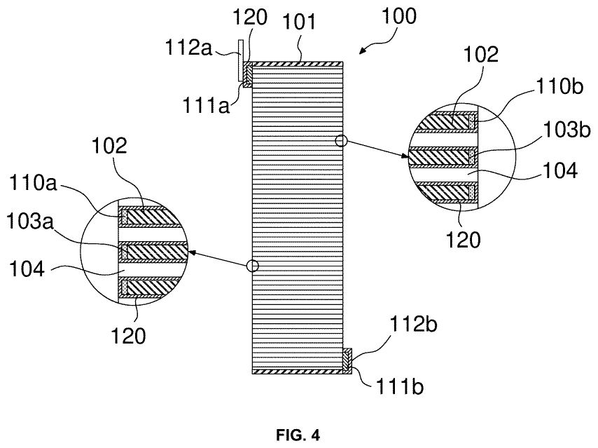

FIG. 1 is a schematic view on a first end face side of a dehumidification device 100 according to an embodiment. FIG. 2 is a cross-sectional view taken along the line a-a′ in FIG. 1. FIG. 3 is a schematic view on a first end face side of a dehumidification device 100 according to another embodiment. FIG. 4 is a cross-sectional view taken along the line a-a′ in FIG. 3.

The dehumidification device 100 includes: a heater element including a honeycomb structure having an outer peripheral wall 101 and partition walls 102 disposed on an inner side of the outer peripheral wall 101, and a pair of electrodes (first electrode 110a and second electrode 110b) provided on the honeycomb structure; and a dehumidifying material-containing layer 120 on surfaces of the partition walls 102. The partition walls 102 define a plurality of cells 104 forming flow paths each extending from a first end face 103a to a second end face 103b.

Each component of the dehumidification device 100 will be described in detail below.

### (1-1. Heater Element)

### (A) Honeycomb Structure

The shape of the honeycomb structure is not particularly limited as long as it has the outer peripheral wall 101 and the partition walls 102 that are located on an inner side of the outer peripheral wall 101 and define a plurality of cells 104 each extending from the first end face 103a to the second end face 103b to form a flow path. For example, an outer shape of a cross section of the honeycomb structure orthogonal to the extending direction of the flow path (the extending direction of the cells 104) can be a polygonal shape (quadrangular (rectangular, square), pentagonal, hexagonal, heptagonal, octagonal, and the like), a rounded shape (circular, elliptic, oval, egg-like, elongated circular, rounded rectangular (quadrangular shape in which each side and each corner is made of a curve, and each side has a larger radius of curvature than that of each corner), and the like), or the like. Also, when the outer shape of the cross section is polygonal, the corners may be chamfered. For the purposes of preventing damages to the honeycomb structure and for easy attachment of other components such as cushioning material to the surface of the outer peripheral wall 101, it is preferable that the corners especially have a round-chamfered shape. The end faces (first end face 103a and second end face 103b) have the same shape as the cross section. The dehumidification device 100 in FIGS. 1 and 2 illustrates an example of a case where the outer shape of the cross section of the honeycomb structure is circular and the outer shape of the honeycomb structure is cylindrical as a whole. The dehumidification device 100 in FIGS. 3 and 4 illustrates an example of a case where the outer shape of the cross section of the honeycomb structure is the round-chamfered rectangle, and the outer shape of the honeycomb structure is the round-chamfered rectangular pillar shape as a whole.

The opening shape of each cell 104 is not particularly limited, but it may be a polygonal shape (quadrangular (oblong, square), pentagonal, hexagonal, heptagonal, and octagonal shape, and the like), a rounded shape (circular, elliptic, oval, egg-like, and elongated circular shape, and the like) in the cross section of the honeycomb structure orthogonal to the extending direction of the flow path. These shapes may be alone or in combination of two or more. Moreover, among these shapes, the quadrangle or the hexagon is preferable. By providing the cells 104 having such a shape, it is possible to reduce the pressure loss when the air flows. Also, when the opening shape of each cell 104 is polygonal, the corners may be round-chamfered. The dehumidification devices 100 in FIGS. 1 to 4 illustrate an example of a case where the opening shape of each cell 104 of the honeycomb structure is square.

The honeycomb structure may be a honeycomb joined body that includes a plurality of honeycomb segments and joining layers that join outer peripheral surfaces (the outer peripheral surfaces of the honeycomb segments parallel to the extending direction of the flow path) of the plurality of honeycomb segments together. The use of the honeycomb joined body can increase the total cross-sectional area of the cells 104, which is important for ensuring the flow rate of air, while suppressing cracking. The joining layer can be formed by using a joining material. The joining material is not particularly limited, but a ceramic material obtained by adding a solvent such as water to form a paste can be used. The joining material may contain a material that has the PTC property, or may contain the same material as the outer peripheral wall 101 and the partition walls 102. In addition to the role of joining the honeycomb segments to each other, the joining material can also be used as an outer peripheral coating material after joining the honeycomb segments.

The thickness, cell density, and cell pitch (or the opening ratio of the cells 104) of the partition walls 102 are preferably determined while taking several factors into consideration. The several factors include the strength of the honeycomb structure, the reduction of pressure loss when air passes through the cells 104, ensuring the amount of the dehumidifying material-containing layer 120 is supported, ensuring the contact area with the air flowing through the cells 104, the electrical resistance between the end faces, and the like.

The term “thickness of the partition walls 102” as used herein refers to a length in which a line segment crosses the partition wall 102 when the center of gravity of adjacent cells 104 is connected by the line segment in the cross section orthogonal to the extending direction of the flow path. The thickness of the partition walls 102 is the average of the thicknesses of all the partition walls 102.

As used herein, the cell density refers to a value obtained by dividing a number of cells by an area of one end face of the honeycomb structure (the total area of the partition walls 102 and the cells 104 excluding the outer peripheral wall 101).

As used herein, the cell pitch refers to a value obtained by the following calculation. First, the area of one end face of the honeycomb structure (the total area of the partition walls 102 and the cells 104 excluding the outer peripheral wall 101) is divided by the number of the cells to calculate an area per a cell. A square root of the area per a cell is then calculated, and this is determined to be the cell pitch.

As used herein, the “opening ratio of the cells 104” refers a value obtained by dividing the total area of the cells 104 defined by the partition walls 102 by the area of one end face (the total area of the partition walls 102 and the cells 104 excluding the outer peripheral wall 101) in the cross section orthogonal to the extending direction of the flow path of the honeycomb structure. It should be noted that when calculating the opening ratio of the cells 104, the pair of electrodes (the first electrode 110a and the second electrode 110b), and layers provided on the partition walls 102 such as the dehumidifying material-containing layer 120 are not taken into account.

In an embodiment that is advantageous from the viewpoint of supporting a sufficient amount of the dehumidifying material-containing layer 120, the thickness of the partition walls 102 is 0.180 mm or less, the cell density is 100 cells/cm² or less, and the cell pitch is 1.0 mm or more. In a preferred embodiment, the thickness of the partition walls 102 is 0.150 mm or less, the cell density is 95 cells/cm² or less, and the cell pitch is 1.2 mm or more. In a more preferred embodiment, the thickness of the partition walls 102 is 0.120 mm or less, the cell density is 90 cells/cm² or less, and the cell pitch is 1.3 mm or more.

From the viewpoints of ensuring the strength of the honeycomb structure and maintaining lower electrical resistance, the lower limit of the thickness of the partition walls 102 is preferably 0.010 mm or more, more preferably 0.020 mm or more, and even more preferably 0.030 mm or more.

From the viewpoints of ensuring the strength of the honeycomb structure, maintaining lower electrical resistance, and increasing a surface area to facilitate reaction, adsorption, and release by the dehumidifying material-containing layer 120, the lower limit of the cell density is 30 cells/cm² or more, and preferably 35 cells/cm² or more, and even more preferably 40 cells/cm² or more.

From the viewpoints of ensuring the strength of the honeycomb structure, maintaining lower electrical resistance and increasing a surface area to facilitate reaction, adsorption and release by the dehumidifying material-containing layer 120, the upper limit of the cell pitch is 2.0 mm or less, more preferably 1.8 mm or less, and even more preferably 1.6 mm or less.

In an embodiment that is advantageous in terms of both reducing pressure loss and maintaining strength, the thickness of the partition walls 102 is 0.08 mm to 0.36 mm, the cell density is 2.54 cells/cm² to 140 cells/cm², and the opening ratio of the cells 104 is 0.70 or more. In a preferred embodiment, the thickness of the partition walls 102 is 0.09 mm to 0.35 mm, the cell density is 15 cells/cm² to 100 cells/cm², and the opening ratio of the cells 104 is 0.75 or more. In a more preferred embodiment, the thickness of the partition walls 102 is 0.10 mm to 0.30 mm, the cell density is 20 cells/cm² to 90 cells/cm², and the opening ratio of the cells 104 is 0.77 or more.

From the viewpoint of ensuring the strength of the honeycomb structure, the upper limit of the opening ratio of the cells 104 is preferably 0.94 or less, more preferably 0.92 or less, and even more preferably 0.90 or less.

Although the thickness of the outer peripheral wall 101 is not particularly limited, it is preferably determined based on the following considerations. First, from the viewpoint of reinforcing the honeycomb structure portion, the thickness of the outer peripheral wall 101 is preferably 0.05 mm or more, more preferably 0.06 mm or more, and even more preferably 0.08 mm or more. On the other hand, when the viewpoint of suppressing the initial current by increasing the electrical resistance and the viewpoint of reducing pressure loss when air flows are considered, the thickness of the outer peripheral wall 101 is preferably 1.0 mm or less, more preferably 0.5 mm, even more preferably 0.4 mm or less, and still more preferably 0.3 mm or less.

As used herein, the thickness of the outer peripheral wall 101 refers to a length, in a normal line direction of the outer peripheral surface, from a boundary between the outer peripheral wall 101 and the outermost cell 104 or partition wall 102 to an outer peripheral surface of the honeycomb structure, in the cross section orthogonal to the extending direction of the flow path of the honeycomb structure.

The length of the honeycomb structure in the extending direction of the flow path and the cross-sectional area of the honeycomb structure orthogonal to the flow path direction may be adjusted according to the required size of the dehumidification device 100, and are not particularly limited. For example, when used in a compact dehumidification device 100 while ensuring a predetermined function, the honeycomb structure can have a length of 2 to 50 mm, typically 5 to 50 mm, in the extending direction of the flow path, and have a cross-sectional area of 30 to 400 cm², typically 50 to 150 cm², which is orthogonal to the extending direction of the flow path.

The partition walls 102 forming the honeycomb structure are made of a material that can be heated by electric conduction, specifically made of a material having the PTC property. Further, the outer peripheral wall 101 may also be made of material having the PTC property, as with the partition walls 102, as needed.

Since the dehumidifying material-containing layer 120 is provided on the partition walls 102, the dehumidifying material-containing layer 120 can be directly heated by heat transfer from the heat-generating partition walls 102 (and optionally the outer peripheral wall 101). Further, the material having the PTC property has characteristics such that when the temperature increases to exceed the Curie point, the resistance value is sharply increased, making it difficult for electricity to flow. Therefore, when the temperature of the heater element becomes high, the current flowing through the partition walls 102 (and the outer peripheral wall 101 if necessary) is limited, thereby suppressing excessive heat generation of the heater element. Therefore, it is possible to suppress thermal deterioration of the dehumidifying material-containing layer 120 due to excessive heat generation.

From the viewpoint of obtaining appropriate heat generation, the lower limit of the volume resistivity at 25° C. of the material having the PTC property is preferably 0.1 Ω·cm or more, more preferably 0.5 Ω·cm or more, even more preferably 1 Ω·cm or more, and still even more preferably 2 Ω·cm or more. From the viewpoint of generating heat with a low driving voltage, the upper limit of the volume resistivity at 25° C. of the material having the PTC property is preferably 50 Ω·cm or less, more preferably 30 Ω·cm or less, even more preferably 18 Ω·cm or less, and still more preferably 16 Ω·cm or less. Thus, the range of volume resistivity at 25° C. of the material having the PTC property can be, for example, 0.1 Ω·cm to 50 Ω·cm. As used herein, the volume resistivity at 25° C. of the material having the PTC property is measured according to JIS K 6271:2008.

From the viewpoints of creating a device that can be heated by electric conduction and has the PTC property, the outer peripheral wall 101 and the partition walls 102 are preferably made of a material containing barium titanate (BaTiO₃) as a main component, more preferably ceramics made of a material containing barium titanate (BaTiO₃)-based crystalline particles in which a part of Ba is substituted with a rare earth element, as a main component. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystalline particles is not particularly limited, but it may generally be 99% by mass or less, and preferably 98% by mass or less.

In terms of reduction of the environmental load, it is desirable that the materials used for the outer peripheral wall 101 and the partition walls 102 are substantially free of lead (Pb). To be more specific, the outer peripheral wall 101 and the partition walls 102 preferably have a Pb content of 0.01% by mass or less, and more preferably 0.001% by mass or less, and still more preferably 0% by mass. The lower Pb content can allow the air heated by contact with the heat-generating partition walls 102 to be safely applied to organisms such as humans, for example. In the outer peripheral wall 101 and the partition walls 102, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

In conventional heater elements, the Curie point of the material that makes up the outer peripheral wall and partition walls is generally a high temperature of 100° C. to 300° C. Therefore, a dehumidifying material having a water release temperature in this temperature range is used in the dehumidifying material-containing layer. However, the dehumidifying material requires a high temperature of 100° C. or more to release adsorbed moisture to be regenerated, so that the amount of required electric energy is increased. As a result, electric power consumption of the battery is increased, so that, for example, the cruising range of electric vehicles is reduced. Also, the high temperature of 100° C. or more can also thermally affect the casing components that house the heater element or other surrounding components, thereby affecting their function and durability.

In contrast, the dehumidifying material-containing layer 120 used in the dehumidification device 100 uses a dehumidifying material that has a water release temperature of 30 to 70° C., so that the Curie point of the material making up the outer peripheral wall 101 and the partition walls 102 can also be lower. In terms of efficiently heating the dehumidifying material-containing layer 120, the material making up the outer peripheral wall 101 and the partition walls 102 preferably has a lower limit of a Curie point of 30° C. or more, more preferably 40° C. or more, and even more preferably 50° C. or more. Further, in terms of safety as a component placed in an interior, in particular, the vehicle interior, or near the vehicle interior, the Curie point is preferably 70° C. or less, and preferably 60° C. or less, and even more preferably 50° C. or less. Therefore, the Curie point of the material making up the outer peripheral wall 101 and the partition walls 102 can be in the range of 30° C. to 70° C., for example.

The Curie point of the material making up the outer peripheral wall 101 and the partition walls 102 may be 100° C. or more, but the electric energy may have to be controlled so that the heating temperature of the dehumidifying material-containing layer 120 is not too high for use in the dehumidification device 100.

The Curie point of the material making up the outer peripheral wall 101 and the partition walls 102 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

Barium titanate having a Curie point of 30° C. to 70° C. is not limited, but it can be represented, for example, by the composition formulae [i] to [iii] below:
[i] (Ba_{1-x-y}SrₓA_{y})TiO₃, in which A represents one or more rare earth elements, x is 0.15 to 0.25 and y is 0.0001 to 0.01;
[ii] (Ba_{1-x-y}SnₓA_{y}) TiO₃, in which A represents one or more rare earth elements, x is 0.05 to 0.15 and y is 0.0001 to 0.01; and
[iii] (Ba_{1-x-y}ZrₓA_{y}) TiO₃, in which A represents one or more rare earth elements, x is 0.12 to 0.18 and y is 0.0001 to 0.01.

As used herein, the Curie point is measured by the following method. A sample is attached to a sample holder for measurement, mounted in a measuring tank (e.g., MINI-SUBZERO MC-810P, from ESPEC). A change in electrical resistance of the sample as a function of a temperature when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### (B) Electrode

The pair of electrodes (a first electrode 110a and a second electrode 110b) can be provided at any points on the honeycomb structure. The pair of electrodes can be provided at opposing positions, for example, on the first end face 103a and the second end face 103b of the honeycomb structure or on the surfaces of the outer peripheral wall 101 that are parallel to the extending direction of the flow path of the honeycomb structure. In particular, from the viewpoint of efficiently heating the honeycomb structure, it is preferable to provide the pair of electrodes on the first end face 103a and the second end face 103b of the honeycomb structure. That is, the first electrode 110a is provided on the first end face 103a, and the second electrode 110b is provided on the second end face 103b. Application of voltage between the pair of electrodes 110a and 110b allows the honeycomb structure to generate heat by Joule heat.

Specifically, the first electrode 110a covers a part or all of the surfaces of the partition walls 102 forming the first end face 103a. The second electrode 110b covers a part or all of the surfaces of the partition walls 102 forming the second end face 103b. In order to facilitate the spreading of the current over the entire first end face 103a, the first electrode 110a covers preferably 80% or more, more preferably 90% or more, and even more preferably 99% or more, of the area of the portions of the first end face 103a that excludes the openings of the cells 104 (partition wall portion and outer peripheral wall portion). Similarly, in order to facilitate the spreading of the current over the entire second end face 103b, the second electrode 110b covers preferably 80% or more, more preferably 90% or more, and even more preferably 99% or more, of the area of the portion of the second end face 103b that excludes the openings of the cells 104 (partition wall portion and outer peripheral wall portion).

The first electrode 110a and the second electrode 110b may employ, for example, a metal or alloy containing at least one selected from Cu, Ag, Al, Ni and Si, although not particularly limited thereto. In a preferred embodiment, the first electrode 110a and the second electrode 110b contain pure aluminum and/or an aluminum alloy. It is also possible to use an ohmic electrode capable of ohmic contact with the outer peripheral wall 101 and/or the partition walls 102 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the first electrode 110a and the second electrode 110b may have a single layer structure, or may have a laminated structure of two or more layers. When the first electrode 110a and the second electrode 110b have the laminated structure of two or more layers, the materials of the respective layers may be of the same type or of different types. In a preferred embodiment, the first electrode 10a and the second electrode 110b have a single layer structure of pure aluminum, a bilayer structure of an Al—Ni alloy layer and a pure silver layer, a bilayer structure of a pure aluminum layer and a pure silver layer, or a bilayer structure of an Al—Ni alloy layer and a pure aluminum layer.

The thickness of the first electrode 110a and the second electrode 110b are not limited, and they may be appropriately set according to the method for forming the first electrode 110a and the second electrode 110b. The method for forming the first electrode 110a and the second electrode 110b includes metal deposition methods such as sputtering, vapor deposition, electrolytic deposition, and chemical deposition. Alternatively, the electrodes can be formed by applying an electrode paste and then baking it, or by thermal spraying. In addition, the electrodes can be formed by joining a metal sheet or alloy sheet, such as perforated metal having through holes at points corresponding to the openings in the cells 104.

The average thickness of the first electrode 110a and the second electrode 110b is not limited, but it can be 5 μm or more and 100 μm or less, for example. The lower limit of the average thickness of the first electrode 110a and the second electrode 110b of 5 μm or more, preferably 10 μm or more, more preferably 20 μm or more, provides the advantage of avoiding abnormal heat generation at the electrodes. The upper limit of the average thickness of the first electrode 110a and the second electrode 110b of 100 μm or less, preferably 80 μm or less, and more preferably 60 μm or less provides the advantages of suppressing the stiffness of the electrodes and making them difficult to peel off from the end surface of the honeycomb structure.

The average thickness of the first electrode 110a is measured by the following procedure. First, a cross-sectional image of the first electrode 110a at magnifications of about 50 is acquired using a scanning electron microscope or the like. The cross-section is parallel to the extending direction of the flow path of the honeycomb structure. Since the first electrode 110a is visible at partition walls 102 in the cross-sectional image, the thickness of the first electrode 110a is measured at the central position, in the direction perpendicular to the extending direction of the flow path, of each partition wall 102 that forms the first end face 103a and is covered with the first electrode 110a. The direction of thickness is parallel to the extending direction of the flow path. Then, many cross-sectional images of the first electrode 110a are acquired without bias from the vicinity of the first end face 103a of the heater element, and the thickness of the first electrode 110a is measured at five or more positions. The average of all measured thicknesses is determined to be the average thickness of the first electrode 110a. The same procedure is used to measure the average thickness of the second electrode 110b.

The lower limit of the volume resistivity of the first electrode 110a and the second electrode 110b at 25° C. is not particularly limited, but the normally achievable range is 1.0×10⁻⁷ Ω·cm or more. From the viewpoint of ensuring sufficient current distribution on the surface and uniform temperature distribution, The upper limit of the volume resistivity of the first electrode 110a and the second electrode 110b at 25° C. is preferably 1.0×10⁻⁵ Ω·cm or less, more preferably 1.0×10⁻⁶ Ω·cm or less, more preferably 5.0×10⁻⁷ Ω·cm or less, and more preferably 3.0×10⁻⁷ Ω·cm. Thus, the range of the volume resistivity of the first electrode 110a and the second electrode 110b at 25° C. can be, for example, 1.0×10⁻⁷ Ω·cm or more and 1.0×10⁻⁵ Ω·cm or less. As used herein, the volume resistivity of the first electrode 110a and the second electrode 110b at 25° C. is measured according to JIS K 6271:2008.

### (C) Terminal

The heater element can further include terminals (first terminal 111a and second terminal 111b) connected to the pair of electrodes (first electrode 110a and second electrode 110b) from the viewpoint of facilitating connection with an external power source. The first terminal 111a is connected to a part of the outer surface of the first electrode 110a. The second terminal 111b is connected to a part of the outer surface of the second electrode 110b.

The method of connecting the first electrode 110a to the first terminal 111a and the second electrode 110b to the second terminal 111b is not particularly limited as long as they are electrically connected. For example, they can be connected by welding, brazing, or mechanical contacting, or the like. The first terminal 111a and the second terminal 111b may be made of any material, including, but not particularly limited to, a metal, for example. Although elemental metals and alloys may be used as the metal, from the viewpoint of selecting materials that are difficult to be oxidized in a humid environment, difficult to cause migration or electric corrosion even under wet conditions, and easy to bond with electrodes, it is preferable to contain one or more of pure aluminum, aluminum alloys, and stainless steel, and for example, the material can be made of pure aluminum, an aluminum alloy, or stainless steel. Other alloys including at least one selected from the group consisting of Cr, Fe, Co, Ni, Cu, and Ti can also be used, with Fe—Ni alloys and phosphor bronze being particularly suitable. It is preferable for the terminal to be made of a material similar to that of the electrode layer on the end face to avoid electric corrosion. By way of example, it is preferred that both the electrode layers and the terminals are pure aluminum and/or aluminum alloy.

The shape of each of the first terminal 111a and the second terminal 111b is not limited, but it can be flat, for example. In such a case, the thickness of each terminal is not limited, but can be, for example, 0.1 to 4 mm, and preferably 0.3 to 2 mm.

The area of the portion of the first end face 103a that is covered with the first terminal 111a is not limited, but if the first terminal 111a is too small, it will be difficult to connect current-conducting components to the first terminal 111a. Conversely, if the first terminal 111a is too large, the area blocking the openings of the cells 104 becomes larger, reducing the air flow rate that can flow to the heater element. Therefore, the lower limit of the ratio of the area of the first terminal 111a that covers the first end face 103a to the area of the first end face 103a is preferably 0.5% or more, more preferably 1% or more, and even more preferably 2% or more. The upper limit of the ratio of the area of the first terminal 111a that covers the first end face 103a to the area of the first end face 103a is preferably 10% or less, more preferably 8% or less, and even more preferably 5% or less. Thus, the range of the ratio of the area of the first terminal 111a that covers the first end face 103a to the area of the first end face 103a can be, for example, 0.5% to 10%. The same is true for the ratio of the area of the second terminal 111b that covers the second end face 103b to the area of the second end face 103b.

The lower limit of the volume resistivity of the first terminal 111a and the second terminal 111b at 25° C. is not particularly limited, but the possible range is normally 1.0×10⁻⁷ Ω·cm or more. From the viewpoint of reducing heat generation loss and energy loss at the terminals, the upper limit of the volume resistivity of the first terminal 111a and second terminal 111b at 25° C. is preferably 1.0×10⁻⁶ Ω·cm or less, preferably 5.0×10⁻⁷ Ω·cm or less, and more preferably 3.0×10⁻⁷ Ω·cm or less, and more preferably 2.0×10⁻⁷ Ω·cm or less. Thus, the range of volume resistivity of the first terminal 111a and the second terminal 111b at 25° C. can be, for example, between 1.0×10⁻⁷ Ω·cm or more and 1.0×10⁻⁶ Ω·cm or less. As used herein, the volume resistivity of the first terminal 111a and the second terminal 111b at 25° C. is measured according to JIS K 6271:2008.

### (D) Current-Conducting Components

The heater element can further include current-conducting components (first current-conducting component 112a and second current-conducting component 112b) connected to the terminals, in view of facilitating connection to an external power source. The first current-conducting component 112a and the second current-conducting component 112b are connected to the first terminal 111a and the second terminal 111b, respectively.

The current-conducting materials making up the first current-conducting component 112a and the second current-conducting component 112bincludestainless steel, aluminum, aluminum alloys, copper alloys, and copper. The method of connecting the first terminal 111a to the first current-conducting component 112a and the second terminal 111b to the second current-conducting component 112b is not limited as long as both are conductive, and they can be connected by welding, brazing or mechanical contacting, for example. In one embodiment, the first current-conducting component 112a and the second current-conducting component 112bmaybe the wire itself between the external power source and the first terminal 111a (second terminal 111b), i.e., copper wire, copper alloy wire, aluminum wire, aluminum alloy wire, stainless steel wire. In another embodiment, the first current-conducting component 112a and the second current-conducting component 112b may be intermediary components that connect the wires to the first terminal 111a (second terminal 111b). The intermediary components can be connected to the wire by any of the following methods: welding, soldering, brazing, caulking, and bolting, for example, or by other methods.

### (1-2. Dehumidifying Material-Containing Layer)

The dehumidifying material-containing layer 120 contains a dehumidifying material having a water release temperature of 30 to 70° C. By using such a dehumidifying material, the adsorbed moisture can be released and regenerated in the low temperature range of 30 to 70° C. This reduces the electric energy required to regenerate the dehumidifying material-containing layer 120 and reduces the electric consumption stored in the battery, thus extending the cruising range of the electric vehicle. The water release temperature of the dehumidifying material is preferably 35 to 65° C., and more preferably 40 to 60° C.

As used herein, the dehumidifying material refers to a substance which, when the substance is left for one hour at room temperature (25° C.) and at 50% relative humidity, is capable of absorbing 5 grams or more of water per gram of its dry mass, and is also called a moisture absorbing material. The moisture absorbing material preferably adsorbs moisture at a temperature between −20° C. and less than 30° C.

Since the dehumidifying material has the function of adsorbing moisture at a temperature between −20° C. and less than 30° C. and separating it at a temperature of 30° C. to 70° C., the function of the dehumidifying material can be repeatedly obtained by repeating electrical conduction and non-electrical conduction.

The temperature difference between the water release temperature of the dehumidifying material and the Curie point of the material having the PTC property (the material making up the outer peripheral wall 101 and the partition walls 102 of the honeycomb structure) is preferably within ±10° C., more preferably within ±8° C., and even more preferably within ±5° C. This configuration can prevent the dehumidifying material from being heated excessively and deteriorated, thus enabling the function of the dehumidifying material-containing layer 120 to be maintained over a long period of time.

The type of the dehumidifying material is not particularly limited as long as the water release temperature is 30 to 70° C., and examples include aluminosilicate, silica gel, silica, graphene oxide, polymer moisture absorbents, polystyrene sulfonic acid, and metal organic frameworks (MOFs: Metal Organic Frameworks). These may be used alone or in combination of two or more.

Examples of the aluminosilicate that can be preferably used herein include AFI type-, CHA type-, or BEA type-zeolite; and porous clay minerals such as allophane and imogolite. Also, it is more preferable that the aluminosilicate is amorphous.

An example of the silica gel that can be preferably used herein is type A silica gel.

Examples of the polymer moisture adsorbents that can be preferably used herein include those having a polyacrylic acid polymer chain. For example, sodium polyacrylate or the like can be used as the polymer moisture adsorbent.

The metal organic framework is a crystalline hybrid material containing metal ions and organic molecules (organic ligands). The metal ions are preferably hydrophilic metal ions (for example, aluminum ions).

The dehumidifying material-containing layer 120 may further contain a binder. The containing of the binder can enhance the retention function of the dehumidifying material-containing layer 120 against the surfaces of the partition walls 102. As the binder, both organic and inorganic binders can be used, but an inorganic binder is preferred. There are no restrictions on the type of inorganic binder used, but alumina sol, silica sol, montmorillonite, boehmite, gamma alumina, and attapulgite can be used. These may be used alone or in combination of two or more. Among these, alumina and silica sols are preferred because they are more likely to ensure adhesion. Between the two, silica sols are preferred.

The dehumidifying material-containing layer 120 may further contain an antimicrobial material. By containing the antimicrobial material, it is possible to suppress the deterioration of the function of the dehumidifying material-containing layer 120 due to the generation of mold and the like, and the deterioration of the environment inside the vehicle interior due to the dispersal of mold into the vehicle interior. The type of antimicrobial material is not limited as long as it has antimicrobial activity and does not inhibit the function of the dehumidifying material. Examples include visible light responsive photocatalysts such as titanium dioxide, silver, copper, and zinc. These may be used alone or in combination of two or more. Among these examples, titanium dioxide is preferred, and porous titanium dioxide is more preferred.

The average thickness of the dehumidifying material-containing layer 120 is not particularly limited, but it can be between 10 μm or more and 500 μm or less, for example. By setting the lower limit of the average thickness of the dehumidifying material-containing layer 120 to 10 μm or more, preferably 30 μm or more, and more preferably 50 μm or more, the moisture absorption performance can be sufficiently ensured. By setting the upper limit of the average thickness of the dehumidifying material-containing layer 120 to 500 μm or less, preferably 300 μm or less, and more preferably 200 μm or less, the rigidity of the dehumidifying material-containing layer 120 can be reduced, making it difficult to peel off.

The average thickness of the dehumidifying material-containing layer 120 is measured using the following procedure. First, a cross-sectional image of the dehumidifying material-containing layer 120 at magnifications of about 50 is acquired using a scanning electron microscope or the like. The cross-section is parallel to the extending direction of the flow path of the honeycomb structure. Since the dehumidifying material-containing layer 120 is visible in the cross-sectional image at two positions across the partition wall 102 for each partition wall 102, the thickness of each dehumidifying material-containing layer 120 is calculated by dividing the overall cross-sectional area from the first end face 103a to the second end face 103b of each dehumidifying material-containing layer 120 by the length from the first end face 103a to the second end face 103b of the partition walls 102 covered with the dehumidifying material-containing layer 120. Then, many cross-sectional images of the dehumidifying material-containing layer 120 are acquired without bias, and the thickness of the dehumidifying material-containing layer 120 is measured at five or more positions. The average of the thicknesses of all measured dehumidifying material-containing layers 120 is determined to be the average thickness of the dehumidifying material-containing layer 120.

The dehumidifying material-containing layer 120 is provided on the surfaces of the partition walls 102. The dehumidifying material-containing layer 120 can also be provided on a part of the outer surfaces of the first electrode 110a and the second electrode 110b. Furthermore, the dehumidifying material-containing layer 120 can also be provided on the side surfaces of the first electrode 110a and the second electrode 110b. Such a configuration makes it possible to suppress the migration of metallic components in the electrodes and short-circuiting between them.

The outer surface of the first electrode 110a refers to the surface on the opposite side of the surface where the first electrode 110a is in contact with the first end face 103a. The outer surface of the second electrode 110b refers to the surface on the opposite side of the surface where the second electrode 110b is in contact with the second end face 103b. The side surface of the first electrode 110a refers to the surface parallel to the thickness direction of the first electrode 110a. The side surface of the second electrode 110b refers to the surface parallel to the thickness direction of the second electrode 110b.

The dehumidifying material-containing layer 120 is provided on “a part” of the outer surface of the first electrode 110a because the part of the outer surface of the first electrode 110a to which the first terminal 111a is connected should not be provided with the dehumidifying material-containing layer 120. Similarly, the dehumidifying material-containing layer 120 is to be provided on “a part” of the outer surface of the second electrode 110b because the part of the outer surface of the second electrode 110b to which the second terminal 111b is connected should not be provided with the dehumidifying material-containing layer 120.

In order to enhance the short-circuit prevention effect, the dehumidifying material-containing layer 120 is preferably provided over 80% or more of the area of the outer surface of the first electrode 110a to which the first terminal 111a is not connected, more preferably 90% or more, and even more preferably 99% or more. Similarly, the dehumidifying material-containing layer 120 is provided over 80% or more of the area of the outer surface of the second electrode 110b to which the second terminal 111b is not connected, more preferably 90% or more, and even more preferably 99% or more.

### (1-3. Other Additional Components)

The dehumidification device 100 may further include additional components known in the art, if necessary. For example, the dehumidification device 100 can further include a frame that can hold the heater element. The protective action of the frame prevents the heater element from being damaged when it is installed in the airflow path, and it can be shaped for easy installation in the air conditioning system while ensuring electrical insulation with the surrounding components.

Although there are no restrictions as to the frame that holds the heater element, the frame according to one embodiment can be configured to hold the heater element from the first end face 103a side and the second end face 103b side. The frame according to another embodiment can be configured so that the heater element can be held from the outer side of the outer peripheral wall 101.

### (2. Method for Producing Dehumidification Device)

Next, the method for producing the dehumidification device 100 will be illustratively described.

First, a method for producing the honeycomb structure forming the heater element includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body(%)=density of honeycomb formed body(g/cm³)/true density of entire ceramic raw material(g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The lower limit of the relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80% or less, and preferably 75% or less.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure portion containing, as a main component, BaTiO₃-based crystal particles in which a part of Ba is substituted with the rare earth element.

Further, maintaining the temperature of the honeycomb formed body between 1150 to 1250° C. can allow the Ba₂TiO₄ crystal particles generated in the firing process to be easily removed, so that the honeycomb structure portion can be densified.

Further, the heating rate of 20 to 600° C./hour from the temperature of 1150 to 1250° C. to the maximum temperature of 1360 to 1430° C. can allow 1.0 to 10.0% by mass of Ba₆Ti1₇O₄₀ crystal particles to be formed in the honeycomb structure portion.

The amount of time the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a honeycomb structure having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

When the honeycomb structure has been obtained, the pair of electrodes (the first electrode 110a and the second electrode 110b) are joined. The first electrode 110a and the second electrode 110b can be formed on the first end face 103a and the second end face 103b of the honeycomb structure by metal deposition methods such as sputtering, vapor deposition, electrolytic deposition, and chemical deposition. Further, the first electrode 110a and the second electrode 110b can also be formed on the first end face 103a and the second end face 103b of the honeycomb structure by applying an electrode paste and then baking it. Furthermore, they can also be formed by thermal spraying. The first electrode 110a and the second electrode 110b may be composed of a single layer, but they may also be composed of a plurality of electrode layers with different compositions. When forming the first electrode 110a and the second electrode 110b on the end faces in the manner as described above, they are set so that the thicknesses of the electrodes are not excessively large, thereby preventing them from blocking the cells 104.

The method of forming the first electrode 110a and the second electrode 110b is not limited, but it includes electrode paste baking, dry plating such as sputtering and vapor deposition, thermal spraying, wet plating such as electrolytic deposition and chemical deposition, and the joining of metal or alloy sheets. Each method has a suitable thickness range. Each of the thicknesses is, for example, about 5 to 30 μm for baking the electrode paste, about 100 to 1000 nm for dry plating such as sputtering and vapor deposition, about 10 to 100 μm for thermal spraying, and about 5 μm to 30 μm for wet plating such as electrolytic deposition and chemical deposition. Further, when joining the metal sheet or alloy sheet, the thickness of each electrode can be about 5 to 100 μm.

Then, the first terminal 111a is connected to the outer surface of the first electrode 110a and the second terminal 111b is connected to the outer surface of the second electrode 110b. The method of connection between the two members may include welding, brazing, or mechanical contacting, as described above. Also, when baking the electrode paste to form the first electrode 110a (or second electrode 110b), the connection can be made by baking the first terminal 111a (or second terminal 111b) at the same time.

Then, if necessary, the first current-conducting component 112a and the second current-conducting component 112b are connected to the first terminal 111a and the second terminal 111b, respectively. The method of connection between the two members may include welding, brazing, or mechanical contacting, as described above.

The dehumidifying material-containing layer 120 is formed at a predetermined position on the heater element obtained as described above. Specifically, the dehumidifying material-containing layer 120 is provided on the surfaces of the partition walls 102 of the honeycomb structure, which makes up the heater element, and on a part of the outer surfaces and side surfaces of the first electrode 110a and the second electrode 110b. The dehumidifying material-containing layers 120 formed at the respective positions may be formed individually or simultaneously.

The dehumidifying material-containing layers 120 can be formed at the same time by the following steps. The heater element created before forming the dehumidifying material-containing layer 120 is immersed in a slurry containing a dehumidifying material, optionally an antimicrobial material, a binder, and a dispersion medium for a predetermined period of time. Excess slurry on the outer peripheral surface of the honeycomb structure is removed by blowing and wiping. The slurry can be then dried to form the dehumidifying material-containing layer 120. The drying can be performed while heating the vehicle air conditioning system to a temperature of about 120 to 600° C., for example. Although this series of steps of immersion, slurry removal, and drying may be performed only once, the steps also can be repeated multiple times to form the dehumidifying material-containing layer 120 having a desired thickness.

An organic binder may be used as the binder, but due to concerns that heat may cause smoke to be generated and components in the smoke may flow into the vehicle interior, which would deteriorate the vehicle interior environment, an inorganic binder is preferred. Suitable types of inorganic binders are described above.

The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof.

### (3. Vehicle Interior Dehumidification System)

The vehicle interior dehumidification system according to an embodiment can be suitably utilized for various vehicles such as automobiles. In particular, the vehicle interior humidification system according to an embodiment can be suitably used for a vehicle that has no internal combustion engine, such as electric vehicles and electric rail cars.

The vehicle interior dehumidification system can also be used to regulate the humidity in the interior spaces of buildings such as homes, offices, factories, stores, warehouses, and freezers, as well as vehicles such as ships and airplanes.

### (3-1. Configuration Example 1 of Vehicle Interior Dehumidification System)

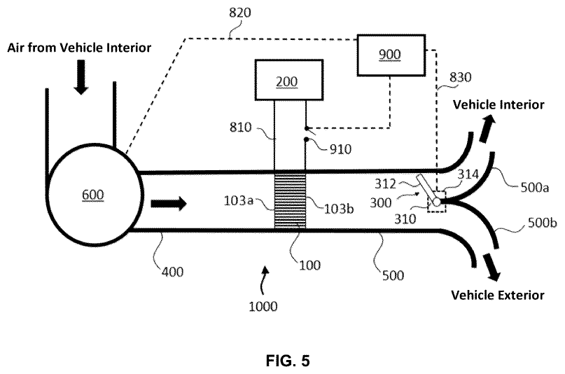

FIG. 5 is a schematic view illustrating a configuration of a vehicle interior dehumidification system 1000 according to an embodiment.

The vehicle interior dehumidification system 1000 includes: a dehumidification device 100; a battery 200 capable of applying voltage to the dehumidification device 100; an inflow pipe 400 for communicating the vehicle interior with an inflow port (inlet end face) of the dehumidification device 100; an outflow pipe 500 for communicating an outflow port (outlet end face) of the dehumidification device 100 with the vehicle interior or vehicle exterior; and a switching valve 300 installed in the outflow pipe 500 and capable of switching the flow of air flowing through the outflow pipe 500 to the vehicle interior or vehicle exterior. The outflow pipe 500 has a first passage 500a that communicates the outflow port (outlet end face) of the dehumidification device 100 with the vehicle interior and a second passage 500b that communicates the outflow port (outlet end face) of the dehumidification device 100 with the vehicle exterior. The vehicle interior dehumidification system 1000 further includes a ventilator 600 for allowing air from the vehicle interior to flow into the inflow port (inlet end face) of the dehumidification device 100 via the inflow pipe 400.

In the vehicle interior dehumidification system 1000 shown in FIG. 5, the dehumidification device 100 is arranged such that the inflow port (inlet end face) is the first end face 103a and the outflow port (outlet end face) is the second end face 103b. However, the dehumidification device 100 can also be arranged such that the inflow port is the second end face 103b and the outflow port is the first end face 103a. A single dehumidification device 100 may be used, or multiple dehumidification devices 100 may be arranged in a series or parallel to each other.

The vehicle interior dehumidification system can have operation modes of: a first mode in which the applied voltage from the battery 200 is turned off, the switching valve 300 is switched so that the air flowing through the outflow pipe 500 passes through the first passage 500a, and the ventilator 600 is turned on; and
a second mode in which the applied voltage from the battery 200 is turned on, the switching valve 300 is switched so that the air flowing through the outflow pipe 500 passes through the second passage 500b, and the ventilator 600 is turned on.

The vehicle interior dehumidification system 1000 can include a control unit 900 capable of performing the switching between the first mode and the second mode. The control unit 900 may be configured, for example, such that the first mode and the second mode can be alternately performed. By repeating the switching between the first mode and the second mode in a fixed cycle, the moisture (water vapor) in the vehicle interior can be stably discharged to the vehicle exterior.

In the first mode, the moisture in the air is removed. Specifically, the air from the vehicle interior flows into the dehumidification device 100 through the inflow pipe 400, passes through the dehumidification device 100 (inlet end face), and then flows out of the dehumidification device 100 (outlet end face). The moisture in the air from the vehicle interior is removed by being adsorbed onto the dehumidifying material in the dehumidifying material-containing layer 120 as it passes through the dehumidification device 100. The moisture-removed air flowing out of the outflow port (outlet end face) of the dehumidification device 100 is returned to the vehicle interior through the first passage 500a of the outflow pipe 500. The air may be fed to other air conditioning systems (e.g., HVAC of a vehicle).

In the second mode, the dehumidifying material in the dehumidifying material-containing layer 120 is regenerated. Specifically, the air from the vehicle interior flows into the dehumidification device 100 through the inflow pipe 400, passes through the dehumidification device 100 (inlet end face), and then flows out of the dehumidification device 100 (outlet end face). The dehumidification device 100 generates heat by electrical conduction, which heats the dehumidifying material-containing layer 120 supported on the dehumidification device 100. This causes the moisture that has been adsorbed on the dehumidifying material-containing layer 120 to be released (separated) from the dehumidifying material-containing layer 120.

To promote the release of the moisture adsorbed in the dehumidifying material-containing layer 120, it is preferable to heat the dehumidifying material at the water release temperature or more, depending on the type of dehumidifying material. For example, at least part (and preferably all) of the dehumidifying material is preferably heated at 30 to 70° C., more preferably at 35 to 65° C., and even more preferably at 40 to 60° C. The second mode is preferably performed for a period of time until the dehumidifying material is fully regenerated. Depending on the type of dehumidifying material, for example, the dehumidifying material is preferably heated in the above temperature range for 1 to 10 minutes, more preferably 2 to 8 minutes, and even more preferably 3 to 6 minutes.

In the second mode, the air from the vehicle interior flows out of the outflow port (outlet end face) of the dehumidification device 100, while being accompanied by the moisture released from the dehumidifying material during passage through the dehumidification device 100. The air containing the moisture that flows out of the outflow port (outlet end face) of the dehumidification device 100 is discharged to the vehicle exterior through the second passage 500b of the outflow pipe 500.

The switching between the turning-on and the turning-off for the applied voltage to the dehumidification device 100 can be performed, for example, by electrically connecting the battery 200 to the pair of terminals (first terminal 111a and second terminal 111b) in the dehumidification device 100 with an electric wire 810 and operating a power switch 910 provided therein. The operation of the power switch 910 can be performed by the control unit 900.

The switching between the turning-on and the turning-off for the ventilator 600 can be performed, for example, by electrically connecting the control unit 900 to the ventilator 600 with an electric wire or wirelessly, and operating a switch (not illustrated) of the ventilator 600 by the control unit 900. The ventilator 600 can also be configured so that the airflow rate can be varied by the control unit 900.

The switching of the switching valve 300 can be performed, for example, by electrically connecting the control unit 900 to the switching valve 300 with an electrical wire or wirelessly, and operating a switch (not shown) of the valve 300 by the control unit 900.

The switching valve 300 is not particularly limited as long as it is electrically driven and has the function of switching the flow path, and includes electromagnetic valves and electric valves. In an embodiment, the switching valve 300 includes an opening/closing door 312 supported by a rotating shaft 310 and an actuator 314 such as a motor for rotating the rotating shaft 310. The actuator 314 is configured to be controllable by the control unit 900.

It is desirable that the vehicle interior dehumidification system 1000 be placed at a position close to the vehicle interior, so that the above functions are stably ensured. Therefore, when considering how to prevent electric shock and the like, it is preferable that the driving voltage is 60V or less. Since the honeycomb structure used in the dehumidification device 100 has a low electrical resistance at room temperature, the honeycomb structure can be heated at the low driving voltage. It should be noted that the lower limit of the driving voltage is not particularly limited, but it may preferably be 10 V or more. If the driving voltage is less than 10V, the current during heating the honeycomb structure becomes large, and as a result the electric wire 810 needs to be thick. Thus, the driving voltage of the vehicle interior dehumidification system 1000 can be between 10 V or more and 60 V or less, for example.

In an embodiment illustrated in FIG. 5, the ventilator 600 is installed on an upstream side of the dehumidification device 100. To be more precise, the ventilator 600 is installed in the middle of the inflow pipe 400 that communicates the dehumidification device 100 with the vehicle interior, and the air passing through the ventilator 600 flows into the dehumidification device 100 so that the air is pushed into it. Alternatively, the ventilator 600 may be provided on a downstream side of the dehumidification device 100. In this case, the ventilator 600 can be installed in the middle of the outflow pipe 500, for example, so that the air passing through the inflow piping 400 flows into the dehumidification device 100 to be sucked into it.

### (3-2. Configuration Example 2 of Vehicle Interior Dehumidification System)

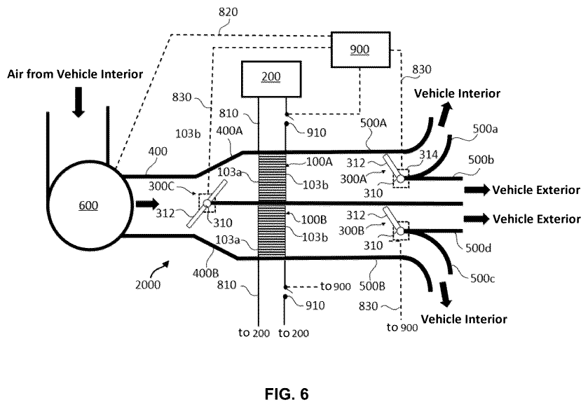

FIG. 6 is a schematic view illustrating a configuration of a vehicle interior dehumidification system 2000 according to another embodiment.

The vehicle interior dehumidification system 2000 includes: a first dehumidification device 100A; a battery 200 capable of applying voltage to the first dehumidification device 100A; a first inflow pipe 400A for communicating the vehicle interior with an inflow port (inlet end face) of the first dehumidification device 100A; an outflow pipe 500A having a first passage 500a for communicating an outflow port (outlet end face) of the first dehumidification device 100A with the vehicle interior, and a second passage 500b for communicating the outflow port (outlet end face) of the first dehumidification device 100A with a vehicle exterior; and a switching valve 300A configured to switch the flow of air flowing through the outflow pipe 500A between the first passage 500a and the second passage 500b.

The vehicle interior dehumidification system 2000 also includes: a second dehumidification device 100B; a battery 200 capable of applying voltage to the second dehumidification device 100B; a second inflow pipe 400B for communicating the vehicle interior with an inflow port (inlet end face) of the second dehumidification device 100B; an outflow pipe 500B having a first passage 500c for communicating an outflow port (outlet end face) of the second dehumidification device 100B with the vehicle interior and a second passage 500d for communicating the outflow port (outlet end face) of the second dehumidification device 100B with the vehicle exterior; and a switching valve 300B configured to switch the flow of the air flowing through the outflow pipe 500B between the first passage 500c and the second passage 500d.

The vehicle interior dehumidification system 2000 also includes: an inflow pipe 400 that branches into the first inflow pipe 400A and the second inflow pipe 400B on a downstream side; and a ventilator 600 for allowing the air from the vehicle interior to flow into the inflow ports (inlet end faces) of the first dehumidification device 100A and the second dehumidification device 100B via the inflow pipe 400.

In the vehicle interior dehumidification system 2000, the first dehumidification device 100A and the second dehumidification device 100B are arranged such that the inflow port (inlet end face) is the first end face 103a and the outflow port (outlet end face) is the second end face 103b. However, the first dehumidification device 100A and second dehumidification device 100B can also be arranged so that the inflow port (inlet end face) is the second end face 103b and the outflow port (outlet end face) is the first end face 103a. For each of the first dehumidification device 100A and the second dehumidification device 100B, one device may be used, or multiple devices may be arranged in a series or parallel to each other.

The vehicle interior dehumidification system 2000 can include a switching valve 300C that has the ability to switch the flow of the air flowing through the inflow pipe 400 between the first inflow pipe 400A and the second inflow pipe 400B. The switching valve 300C can also be set to vary the ratio of the air flowing to the first inflow pipe 400A and the second inflow pipe 400B, while feeding the flow of the air to both pipes. Also, the vehicle interior dehumidification system 2000 has two routes: one passing through the first dehumidification device 100A; and the other passing through the second dehumidification device 100B, whereby it has an advantage that this system can be continued to operate in the event of a failure of one route.

The vehicle interior dehumidification system 2000 can be operated by a first mode in which:
the applied voltage from the battery 200 to the first dehumidification device 100A is turned on;
the switching valve 300A is switched so that the air flowing through the outflow pipe 500A passes through the second passage 500B;
the applied voltage from the battery 200 to the second dehumidification device 100B is turned off;
the switching valve 300B is switched so that the air flowing through the outflow pipe 500B passes through the first passage 500c;
the switching valve 300C is set so that the air flowing through the inflow pipe 400 can be fed to both of the first inflow pipe 400A and the second inflow pipe 400B; and
the ventilator 600 is turned on.

The vehicle interior dehumidification system 2000 can be operated by a second mode in which:
the applied voltage from the battery 200 to the first dehumidification device 100A is turned off;
the switching valve 300A is switched so that the air flowing through the outflow pipe 500A passes through the first passage 500a;
the applied voltage from the battery 200 to the second dehumidification device 100B is turned on;
the switching valve 300B is switched so that the air flowing through the outflow pipe 500B passes through the second passage 500d;
the switching valve 300C is set so that the air flowing through the inflow pipe 400 can be fed to both of the first inflow pipe 400A and the second inflow pipe 400B; and
the ventilator 600 is turned on.

In the first mode, the dehumidifying material in the dehumidifying material-containing layer 120 is regenerated in the first dehumidification device 100A, while the moisture in the air is removed in the second dehumidification device 100B. In the second mode, the moisture in the air is removed in the first dehumidification device 100A, while the dehumidifying material in the dehumidifying material-containing layer 120 is regenerated in the second dehumidification device 100B. In other words, the vehicle interior dehumidification system 2000 can simultaneously perform the regeneration of the dehumidifying material in the dehumidifying material-containing layer 120 and the removal of the moisture. When the dehumidifying material in the dehumidifying material-containing layer 120 needs to be regenerated in the first dehumidification device 100A, the moisture in the air can be removed in the second dehumidification device 100B, and vice versa.

In the first mode, the switching valve 300C is preferably set to increase the flow rate of the air flowing into the second dehumidification device 100B. In the second mode, the switching valve 300C is preferably set to increase the flow rate of the air flowing into the first dehumidification device 100A. This improves by the dehumidifying material's ability to remove the moisture from the air in the dehumidifying material-containing layer 120.

The moisture-removed air that flows out of the outflow port (outlet end face) of the first dehumidification device 100A (or second dehumidification device 100B) is returned to the vehicle interior through the first passage 500a (or first passage 500c) of the outflow pipe 500A (or outflow pipe 500B). The air may be fed to other air conditioning systems (e.g., HVAC of a vehicle). The air containing the moisture released from the dehumidifying material-containing layer 120 flows out of the outflow port (outlet end face) of the first dehumidification device 100A (second dehumidification device 100B) and is discharged to the vehicle exterior through the second passage 500b (or second passage 500d) of the outflow pipe 500A (or outflow pipe 500B).

The vehicle interior dehumidification system 2000 can include a control unit 900 capable of performing the switching between the first mode and the second mode. The control unit 900 may be configured, for example, such that the first mode and the second mode can be alternately performed. By repeating the switching between the first mode and the second mode in a fixed cycle, it is possible to stably discharge the moisture from the vehicle interior to the vehicle exterior. In particular, according to the vehicle interior dehumidification system 2000, the moisture removal can be continued by repeating the first mode and the second mode alternately. This solves the problem that the moisture could not be removed while regenerating the dehumidifying material.

The switching between the turning-on and turning-off of the applied voltage to the first dehumidification device 100A and the second dehumidification device 100B can be performed, for example, by electrically connecting the battery 200 to the pair of terminals (first terminal 111a and second terminal 111b) of the first dehumidification device 100A (second dehumidification device 100B) with an electric wire 810 and operating a power switch 910 provided in the middle of the electric wire. The operation of the power switch 910 can be performed by the control unit 900.

The switching between the turning-on and turning-off of the ventilator 600 can be performed, for example, by electrically connecting the control unit 900 to the ventilator 600 with the electric wire 820 or wirelessly, and operating a switch (not shown) of the ventilator 600 by the control unit 900. The ventilator 600 can also be configured so that the airflow rate can be varied by the control unit 900.

The switching valves 300A, 300B, 300C can be switched, for example, by electrically connecting the control unit 900 to the switching valves 300A, 300B, 300C by the electric wire 830 or wirelessly, and operating switches (not illustrated) of the switching valves 300A, 300B, 300C by the control unit 900.

The switching valves 300A, 300B, 300C are not particularly limited as long as they are electrically driven and have the function of switching the flow path. The switching valves may be electromagnetic valves or electric valves. In an embodiment, each of the switching valves 300A, 300B, 300C includes an opening/closing door 312 supported by a rotating shaft 310 and an actuator 314 such as a motor for rotating the rotating shaft 310. The actuator 314 is configured to be controllable by the control unit 900.

In the vehicle interior dehumidification system 2000, the first dehumidification device 100A and the second dehumidification device 100B are preferably disposed at positions close to the vehicle interior from the viewpoint of ensuring the above functions in a stable manner. Therefore, from the viewpoint of preventing electric shock and the like, it is preferable that the driving voltage is 60V or less. Since the honeycomb structures used in the first dehumidification device 100A and the second dehumidification device 100B have a low electrical resistance at room temperature, the honeycomb structures can be heated at the low driving voltage. It should be noted that the lower limit of the driving voltage is not particularly limited, but it may preferably be 10 V or more. If the driving voltage is less than 10V, the current during heating the honeycomb structure becomes large, and as a result the electric wire 810 needs to be thick. Thus, the driving voltage of the vehicle interior dehumidification system 2000 can be between 10 V or more and 60 V or less, for example.

In an embodiment illustrated in FIG. 6, the ventilator 600 is installed on upstream sides of the first dehumidification device 100A and the second dehumidification device 100B. More specifically, the ventilator 600 is installed in the middle of the inflow pipe 400, and the air passing through the ventilator 600 is pushed into the first dehumidification device 100A and the second dehumidification device 100B to flow through them. Alternatively, the ventilator 600 may be installed on downstream sides of the first dehumidification device 100A and the second dehumidification device 100B. In this case, the ventilators 600 can be installed in the middle of the outflow pipes 500A and 500B, for example, so that the air passing through the inflow pipe 400 is sucked into the first dehumidification device 100A and the second dehumidification device 100B to flow through them.

Aspects of one or more embodiments described above may be summarized as follows.
(1) An aspect of one or more embodiments may be a dehumidification device that may include:
a heater element comprising: a honeycomb structure having an outer peripheral wall and partition walls disposed on an inner side of the outer peripheral wall, the partition walls defining a plurality of cells, each of the cells extending from a first end face to a second end face of the honeycomb structure to form a flow path, at least the partition walls being made of a material having a positive temperature coefficient (PTC) property; and a pair of electrodes provided on the honeycomb structure; and
a dehumidifying material-containing layer provided on surfaces of the partition walls, the dehumidifying material-containing layer comprising a dehumidifying material having a water release temperature of 30 to 70° C.
(2) The dehumidification device according to (1), wherein the material having the PTC property may have a Curie point of 30 to 70° C.
(3) The dehumidification device according to (2), wherein a temperature difference between the water release temperature of the dehumidifying material and the Curie point of the material having the PTC property may be within +10° C.
(4) The dehumidification device according to any one of (1) to (3), wherein the dehumidifying material may be one or more selected from aluminosilicates, silica gel, silica, graphene oxide, polymer adsorbents, polystyrene sulfonic acid and metal organic structures.
(5) The dehumidification device according to any one of (1) to (4), wherein the material having the PTC property may contain barium titanate as a main component.
(6) The dehumidification device according to (5), wherein the barium titanate may be one or more selected from the following [i] to [iii]:
[i] (Ba_{1-x-y}SrₓA_{y}) TiO₃, in which A represents one or more rare earth elements, x is 0.15 to 0.25 and y is 0.0001 to 0.01;
[ii] (Ba_{1-x-y}SnₓA_{y}) TiO₃, in which A represents one or more rare earth elements, x is 0.05 to 0.15 and y is 0.0001 to 0.01; and
[iii] (Ba_{1-x-y}ZrₓA_{y}) TiO₃, in which A represents one or more rare earth elements, x is 0.12 to 0.18 and y is 0.0001 to 0.01.
(7) The dehumidification device according to any one of (1) to (6), wherein the dehumidification material-containing layer may further include an antimicrobial material.
(8) The dehumidification device according to (7), wherein the antimicrobial material may be one or more selected from visible light responsive photocatalysts, silver, copper and zinc.
(9) The dehumidification device according to any one of (1) to (8), wherein the pair of electrodes mya be provided on the first end face and the second end face, respectively.
(10) The dehumidification device according to (9), wherein terminals connected to the pair of electrodes may be further included.
(11) An aspect of one or more embodiments may be a heater element for dehumidification devices. The heater element may include:
a honeycomb structure having an outer peripheral wall and partition walls disposed on an inner side of the outer peripheral wall, the partition walls defining a plurality of cells, each of the cells extending from a first end face to a second end face to form a flow path, at least the partition walls being made of a material having a positive temperature coefficient (PTC) property; and a pair of electrodes provided on the honeycomb structure,
wherein the material having the PTC property has a Curie point of 30 to 70° C.
(12) The heater element for dehumidification devices according to (11), wherein the material having the PTC property may contain barium titanate as a main component.
(13) The heater element for dehumidification devices according to (12), wherein the barium titanate may be one or more selected from the following [i] to [iii]:
[i] (Ba_{1-x-y}SrₓA_{y})TiO₃, in which A represents one or more rare earth elements, x is 0.15 to 0.25 and y is 0.0001 to 0.01;
[ii] (Ba_{1-x-y}SnₓA_{y})TiO₃, in which A represents one or more rare earth elements, x is 0.05 to 0.15 and y is 0.0001 to 0.01; and
[iii] (Ba_{1-x-y}ZrₓA_{y})TiO₃, in which A represents one or more rare earth elements, x is 0.12 to 0.18 and y is 0.0001 to 0.01.
(14) An aspect of one or more embodiments may be a vehicle interior dehumidification system that may include:
the dehumidification device according to any one of (1) to (10);
a battery configured to apply voltage to the dehumidification device;
an inflow pipe communicating a vehicle interior with an inflow port of the dehumidification device;
an outflow pipe communicating an outflow port of the dehumidification device with the vehicle interior and a vehicle exterior;
a switching valve provided in the outflow pipe, the switching valve configured to switch the flow of air flowing through the outflow pipe to the vehicle interior or the vehicle exterior.

### DESCRIPTION OF REFERENCE NUMERALS

100 dehumidification device
101 outer peripheral wall
102 partition wall
103a first end face
103b second end face
104 cell
110a first electrode
110b second electrode
111a first terminal
111b second terminal
112a first current-conducting component
112b second current-conducting component
120 dehumidifying material-containing layer
200 battery
300, 300A, 300B, 300C switching valve
310 rotating shaft
312 opening/closing door
314 actuator
400 inflow pipe
400A first inflow pipe
400B second inflow pipe
500, 500A, 500B outflow pipe
500a, 500c first passage
500b, 500d second passage
600 ventilator
810, 820, 830 electric wire
900 control unit
910 power switch
1000, 2000 vehicle interior dehumidification system

1. A dehumidification device, comprising:
a heater element comprising: a honeycomb structure having an outer peripheral wall and partition walls provided on an inner side of the outer peripheral wall, the partition walls defining a plurality of cells, each of the cells extending from a first end face to a second end face of the honeycomb structure to form a flow path, at least the partition walls being made of a material having a positive temperature coefficient (PTC) property; and a pair of electrodes provided on the honeycomb structure; and
a dehumidifying material-containing layer provided on surfaces of the partition walls, the dehumidifying material-containing layer comprising a dehumidifying material having a water release temperature of 30 to 70° C.

2. The dehumidification device according to claim 1, wherein the material having the PTC property has a Curie point of 30 to 70° C.

3. The dehumidification device according to claim 2, wherein a temperature difference between the water release temperature of the dehumidifying material and the Curie point of the material having the PTC property is within ±10° C.

4. The dehumidification device according to claim 1, wherein the dehumidifying material is one or more selected from aluminosilicates, silica gel, silica, graphene oxide, polymer adsorbents, polystyrene sulfonic acid and metal organic structures.

5. The dehumidification device according to claim 1, wherein the material having the PTC property contains barium titanate as a main component.

6. The dehumidification device according to claim 5, wherein the barium titanate is one or more selected from the following [i] to [iii]:
[i] (Ba_{1-x-y}SrₓA_{y})TiO₃, in which A represents one or more rare earth elements, x is 0.15 to 0.25 and y is 0.0001 to 0.01;
[ii] (Ba_{1-x-y}SnₓA_{y})TiO₃, in which A represents one or more rare earth elements, x is 0.05 to 0.15 and y is 0.0001 to 0.01; and
[iii] (Ba_{1-x-y}ZrₓA_{y})TiO₃, in which A represents one or more rare earth elements, x is 0.12 to 0.18 and y is 0.0001 to 0.01.

7. The dehumidification device according to claim 1, wherein the dehumidifying material-containing layer further comprises an antimicrobial material.

8. The dehumidification device according to claim 7, wherein the antimicrobial material is one or more selected from visible light responsive photocatalysts, silver, copper and zinc.

9. The dehumidification device according to claim 1, wherein the pair of electrodes are provided on the first end face and the second end face, respectively.

10. The dehumidification device according to claim 9, further comprising terminals connected to the pair of electrodes.

11. A heater element for dehumidification devices, the heater element comprising:
a honeycomb structure having an outer peripheral wall and partition walls provided on an inner side of the outer peripheral wall, the partition walls defining a plurality of cells, each of the cells extending from a first end face to a second end face to form a flow path, at least the partition walls being made of a material having a positive temperature coefficient (PTC) property; and a pair of electrodes provided on the honeycomb structure,
wherein the material having the PTC property has a Curie point of 30 to 70° C.

12. The heater element for dehumidification devices according to claim 11, wherein the material having the PTC property contains barium titanate as a main component.

13. The heater element for dehumidification devices according to claim 12, wherein the barium titanate is one or more selected from the following [i] to [iii]:
[i] (Ba_{1-x-y}SrₓA_{y})TiO₃, in which A represents one or more rare earth elements, x is 0.15 to 0.25 and y is 0.0001 to 0.01;
[ii] (Ba_{1-x-y}SnₓA_{y})TiO₃, in which A represents one or more rare earth elements, x is 0.05 to 0.15 and y is 0.0001 to 0.01; and
[iii] (Ba_{1-x-y}ZrₓA_{y})TiO₃, in which A represents one or more rare earth elements, x is 0.12 to 0.18 and y is 0.0001 to 0.01.

14. A vehicle interior dehumidification system, comprising:
the dehumidification device according to claim 1;
a battery configured to apply voltage to the dehumidification device;
an inflow pipe communicating a vehicle interior with an inflow port of the dehumidification device;
an outflow pipe communicating an outflow port of the dehumidification device with the vehicle interior and a vehicle exterior;
a switching valve provided in the outflow pipe, the switching valve being configured to switch the flow of air flowing through the outflow pipe to the vehicle interior or the vehicle exterior.

15. The dehumidification device according to claim 2, wherein the dehumidifying material is one or more selected from aluminosilicates, silica gel, silica, graphene oxide, polymer adsorbents, polystyrene sulfonic acid and metal organic structures.

16. The dehumidification device according to claim 3, wherein the dehumidifying material is one or more selected from aluminosilicates, silica gel, silica, graphene oxide, polymer adsorbents, polystyrene sulfonic acid and metal organic structures.

17. The dehumidification device according to claim 2, wherein the material having the PTC property contains barium titanate as a main component.

18. The dehumidification device according to claim 3, wherein the material having the PTC property contains barium titanate as a main component.

19. The dehumidification device according to claim 2, wherein the dehumidifying material-containing layer further comprises an antimicrobial material.

20. The dehumidification device according to claim 3, wherein the dehumidifying material-containing layer further comprises an antimicrobial material.

21. The dehumidification device according to claim 2, wherein the pair of electrodes are provided on the first end face and the second end face.

22. The dehumidification device according to claim 3, wherein the pair of electrodes are provided on the first end face and the second end face.

23. A vehicle interior dehumidification system, comprising:
the dehumidification device according to claim 2;
a battery capable of applying voltage to the dehumidification device;
an inflow pipe for communicating a vehicle interior with an inflow port of the dehumidification device;
an outflow pipe for communicating an outflow port of the dehumidification device with the vehicle interior and a vehicle exterior;
a switching valve disposed in the outflow pipe, the switching valve being capable of switching the flow of air flowing through the outflow pipe to the vehicle interior or the vehicle exterior.

24. A vehicle interior dehumidification system, comprising:
the dehumidification device according to claim 3;
a battery capable of applying voltage to the dehumidification device;
an inflow pipe for communicating a vehicle interior with an inflow port of the dehumidification device;
an outflow pipe for communicating an outflow port of the dehumidification device with the vehicle interior and a vehicle exterior;
a switching valve disposed in the outflow pipe, the switching valve being capable of switching the flow of air flowing through the outflow pipe to the vehicle interior or the vehicle exterior.
